(19) United States
(12) Patent Application Publication
(10) Pub. No.: US 2018/0192198 A1
(43) Pub. Date: Jul. 5, 2018

(54) PERFORATED DIAPHRAGM FOR AN ACOUSTIC DEVICE

(71) Applicant: Unisound, Inc., Palo Alto, CA (US)

(72) Inventor: Runar Kjølle Nilsskog, Palo Alto, CA (US)

(21) Appl. No.: 15/859,193

(22) Filed: Dec. 29, 2017

Related U.S. Application Data
(60) Provisional application No. 62/440,276, filed on Dec. 29, 2016.

(51) Int. Cl. H04R 7/04; H04R 7/20

(52) U.S. Cl. CPC H04R 7/04; H04R 7/20

(57) ABSTRACT

Certain aspects of the technology disclosed herein involve an apparatus and method of operation for an audio device having a perforated diaphragm. Perforations extend along a plane of the perforated diaphragm. A driver is attached to the perforated diaphragm. The driver includes a voice coil. The driver is configured to cause the perforated diaphragm to vibrate. Vibrations in areas between parallel perforations act as independent audio sources.

### CLAIM FOR PRIORITY

This application claims the benefit of U.S. Provisional Application No. 62/440,276, entitled “SOUND AMPLIFICATION USING A PERFORATED DIAPHRAGM”, filed on Dec. 29, 2016, which is incorporated herein by reference in its entirety.

### TECHNICAL FIELD

The present application relates generally to audio amplification, and more specifically to amplification of sound by an audio device having a perforated diaphragm.

### BACKGROUND

A diaphragm is a transducer intended to convert mechanical vibration to sound. A diaphragm vibrated by a source of energy beats against the air, creating sound waves. In a loudspeaker, a diaphragm is typically a thin, conical membrane commonly made from paper and paper composites.

### SUMMARY

Certain aspects of the technology disclosed herein involve an apparatus and method of operation for an audio device having a perforated diaphragm. Perforations extend along a plane of the perforated diaphragm. A driver is attached to the perforated diaphragm. The driver includes a voice coil. The driver is configured to cause the perforated diaphragm to vibrate. Vibrations in areas between parallel perforations act as independent audio sources.

### BRIEF DESCRIPTION OF THE DRAWINGS

FIG. 1 is an illustration of a ceiling-mountable speaker, according to an embodiment.

FIG. 2 is an illustration of a ceiling-mountable speaker from various angles, according to an embodiment.

FIG. 3 is an illustration of a speaker mounted in a ceiling, according to an embodiment.

FIG. 4 is an exploded diagram of a ceiling-mountable speaker, according to an embodiment.

FIG. 5 is another exploded diagram of a ceiling-mountable speaker, according to an embodiment.

FIG. 6 is an illustration of a conic cover for a ceiling-mountable speaker, according to an embodiment.

FIG. 7 is an illustration of a conic cover for a ceiling-mountable speaker, according to an embodiment.

FIG. 8 is an illustration of a conic cover for a ceiling-mountable speaker, according to an embodiment.

FIG. 9 is an illustration of a perforated diaphragm for a ceiling-mountable speaker, according to an embodiment.

FIGS. 10A-10B are illustrations of a perforated diaphragm for a ceiling-mountable speaker, according to an embodiment.

FIGS. 11A-11J are illustrations of a perforated diaphragm for a ceiling-mountable speaker, according to an embodiment.

FIG. 12 is an illustration of a frame for a ceiling-mountable passive loudspeaker, according to an embodiment.

FIG. 13 is an illustration of a ceiling mount for a ceiling-mountable speaker, according to an embodiment.

FIG. 14 is a diagrammatic representation of a computer system within which the above-described apparatus may be implemented, and within which a set of instructions for causing the machine to perform any one or more of the methodologies or modules discussed herein may be executed.

### DETAILED DESCRIPTION

Certain aspects of the technology disclosed herein involve an apparatus and method of operation for an audio device having a perforated diaphragm. The perforated diaphragm includes a series of parallel perforations extending a length of the perforated diaphragm. A driver is attached to the perforated diaphragm. The driver includes a voice coil. The driver causes the perforated diaphragm to vibrate. Vibrations in areas between parallel perforations act as independent tunable audio sources. The areas between parallel perforations can be tuned by adjusting dimensions of the areas (e.g., changing a width and/or length of an area).

A diaphragm is a transducer intended to convert mechanical vibration to sound. A diaphragm vibrated by a source of energy beats against the air, creating sound waves. In a loudspeaker, a diaphragm is typically a thin, conical membrane commonly made from paper and paper composites. The diaphragm is attached to a voice coil which moves in a magnetic gap, vibrating the diaphragm, and producing sound.

Conventional planar speakers include a ribbon (e.g., ultra-thin aluminum foil), which is a thin metal-film suspended in a magnetic field that servers as a driver on an ultra-thin (e.g., less than a millimeter thick), flexible diaphragm (e.g., a mylar sheet). An electrical signal is applied to the ribbon, which causes the ribbon to move the diaphragm to create sound. Because of the ultra-thin diaphragm, ribbon loudspeakers are often very fragile, and can typically be torn by a strong gust of air. In a conventional planar magnetic speaker, the driver covers a majority of the membrane surface and reduces resonance problems inherent in ultra-thin diaphragms. The current flowing through the driver interacts with the magnetic field of carefully placed magnets on either side of the diaphragm, causing the membrane to vibrate more or less uniformly. The magnetic field requires extremely powerful magnets, which makes ribbon speakers costly to manufacture. Ribbon speakers have a very low resistance that most amplifiers cannot drive directly. As a result, a step down transformer is typically used to increase the current through the ribbon. The transformer must be carefully designed so that its frequency response and parasitic losses do not degrade the sound, further increasing cost and complication relative to conventional designs.

The technology disclosed herein overcomes the deficiencies of conventional planar speakers. The disclosed speaker includes a diaphragm that is substantially stronger than conventional planar speaker and lacks resonance problems inherent in ultra-thin diaphragms. In addition, the disclosed speaker includes a driver (e.g., an electrodynamic exciter) attached to the diaphragm rather than a ribbon (e.g., a metal-film driver) attached to the diaphragm. Thus, problems with ribbons including requiring an extremely powerful magnetic field and low resistance requiring a step down transformer are not present in the disclosed speaker.

In addition, the technology disclosed enhances sound quality in ways not possible with conventional planar speakers. By including a perforated diaphragm, the disclosed speakers have unique vibrational characteristics that greatly enhance sound quality. The perforated diaphragm enhances sound quality due to additional flexibility caused by including a series of parallel perforations and creation of regions between neighboring perforations of the series of parallel perforations that each independently generate sound. Perforations in the diaphragm increase elastic deflection of the diaphragm enabling vibrational waves to more easily propagate through the diaphragm. The perforations in the diaphragm can be patterned as a series of parallel perforations. Vibrations in areas between neighboring perforations displace proximate air and act as a series of parallel sound sources. Sound waves emanating from the diaphragm have an amplitude equal to a vector sum of the amplitudes of the combined waveforms originating from areas between neighboring perforations. Thus, the areas between perforations can act as a line array loudspeaker system where an interference pattern between stacked sound sources results in superior maintenance of sound pressure over distance than occurs with a single sound source.

### Terminology

Brief definitions of terms, abbreviations, and phrases used throughout this application are given below.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described that may be exhibited by some embodiments and not by others. Similarly, various requirements are described that may be requirements for some embodiments but not others.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements. The coupling or connection between the elements can be physical, logical, or a combination thereof. For example, two devices may be coupled directly, or via one or more intermediary channels or devices. As another example, devices may be coupled in such a way that information can be passed there between, while not sharing any physical connection with one another. Additionally, the words “herein,” “above,” “below,” and words of similar import, when used in this application, shall refer to this application as a whole and not to any particular portions of this application. Where the context permits, words in the Detailed Description using the singular or plural number may also include the plural or singular number respectively. The word “or,” in reference to a list of two or more items, covers all of the following interpretations of the word: any of the items in the list, all of the items in the list, and any combination of the items in the list.

If the specification states a component or feature “may,” “can,” “could,” or “might” be included or have a characteristic, that particular component or feature is not required to be included or have the characteristic.

The term “module” refers broadly to software, hardware, or firmware components (or any combination thereof). Modules are typically functional components that can generate useful data or another output using specified input(s). A module may or may not be self-contained. An application program (also called an “application”) may include one or more modules, or a module may include one or more application programs.

The terminology used in the Detailed Description is intended to be interpreted in its broadest reasonable manner, even though it is being used in conjunction with certain examples. The terms used in this specification generally have their ordinary meanings in the art, within the context of the disclosure, and in the specific context where each term is used. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that the same element can be described in more than one way.

Consequently, alternative language and synonyms may be used for any one or more of the terms discussed herein, but special significance is not to be placed upon whether or not a term is elaborated or discussed herein. A recital of one or more synonyms does not exclude the use of other synonyms. The use of examples anywhere in this specification, including examples of any terms discussed herein, is illustrative only and is not intended to further limit the scope and meaning of the disclosure or of any exemplified term. Likewise, the disclosure is not limited to various embodiments given in this specification.

### Audio Device

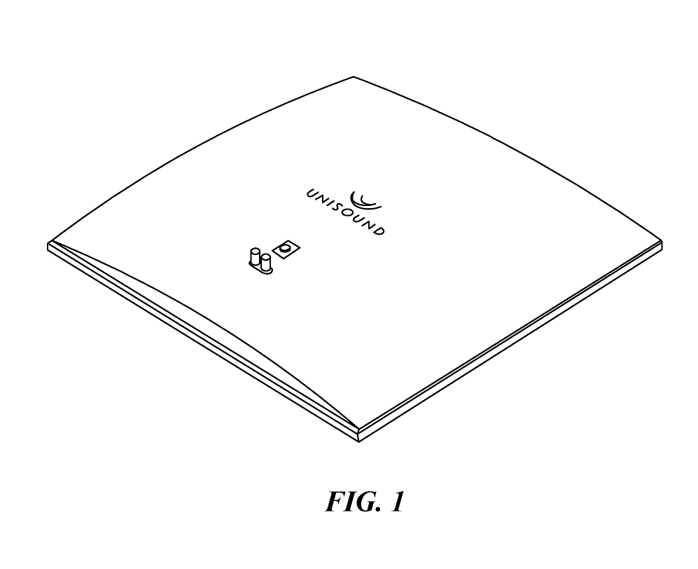

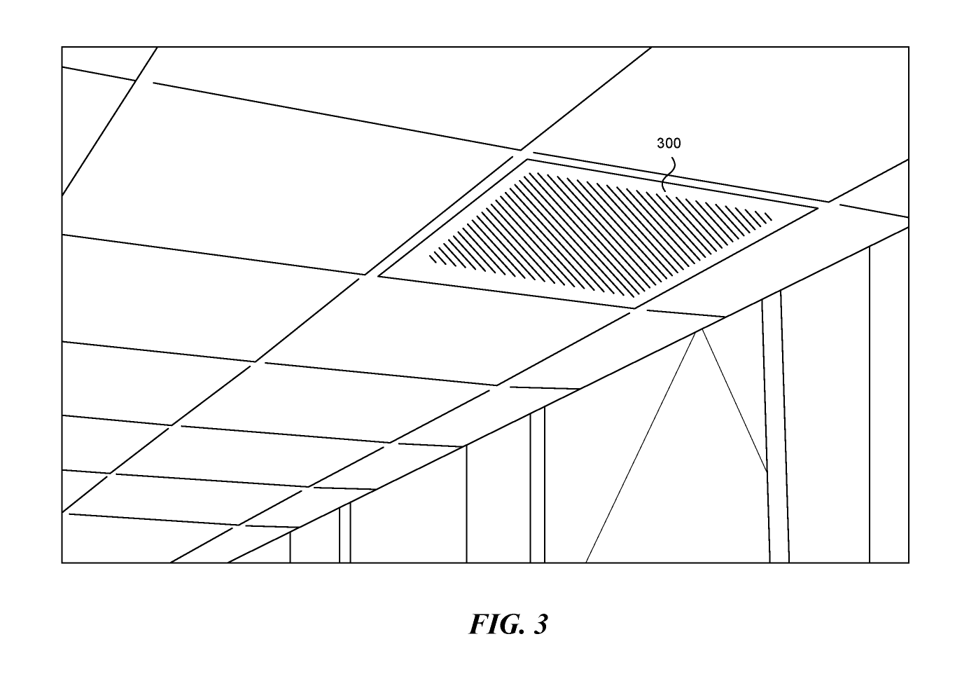

FIG. 1 is an illustration of a ceiling-mountable speaker, according to an embodiment. The ceiling-mountable speaker can include a cover (e.g., a conic cover), a diaphragm (e.g., a perforated diaphragm), a driver (e.g., an electrodynamic exciter), a frame, a lining, and (optionally) a ceiling mount. In an embodiment, the speaker can be mounted into a ceiling as illustrated in FIG. 3. In an embodiment, the speaker can be mounted onto any surface including, for example, a ceiling, wall, furniture, etc.

In an embodiment, the speaker can be passive. In a passive speaker, a low-level audio signal is amplified by an external power amplifier before being sent to the speaker where the signal is sent to the drivers. In another embodiment, the speaker can be powered. In a powered speaker, the power amplifier is included within the loudspeaker enclosure.

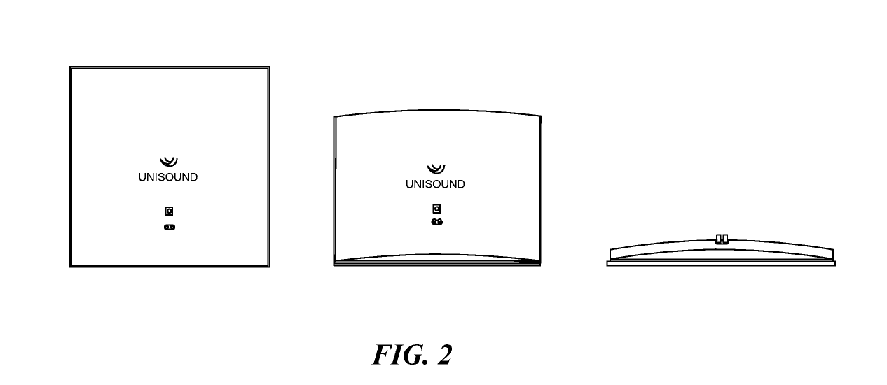

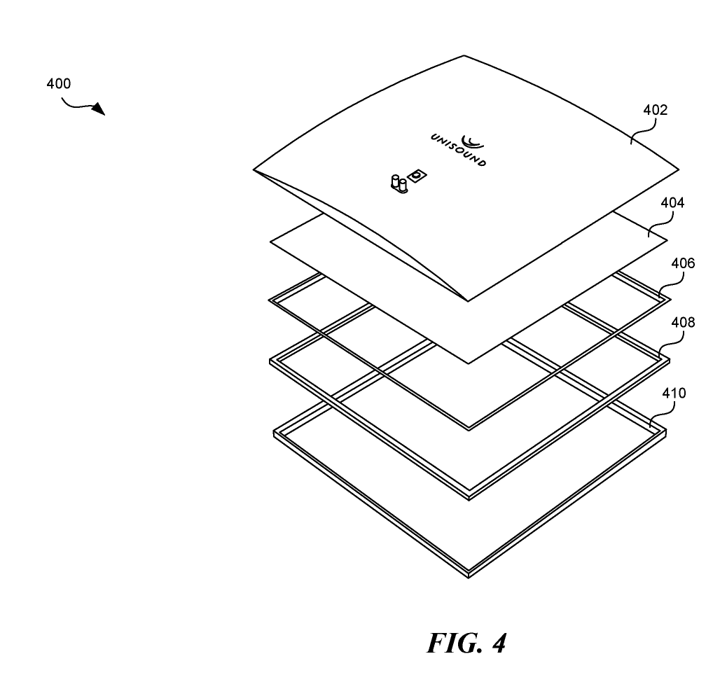

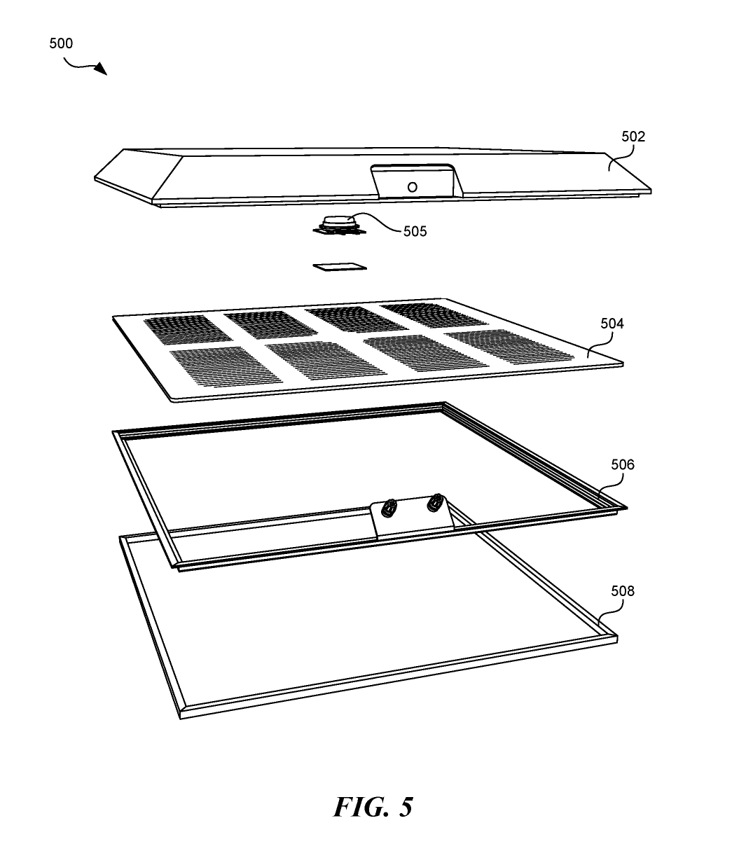

FIG. 2 is an illustration of a ceiling-mountable speaker from various angles, according to an embodiment. An upper portion of the speaker is the cover and a lower surface of the speaker is the diaphragm. The driver can be concealed within an acoustic device. An exploded view of the ceiling-mountable speaker is provided below with reference to FIGS. 4-5.

FIG. 3 is an illustration of an acoustic device 300 mounted in a ceiling, according to an embodiment. The acoustic device 300 can embed seamlessly into a ceiling such that a lower surface of the acoustic device 300 is substantially flush with the ceiling. If a ceiling includes suspended ceiling tiles, the acoustic device 300 can be inserted in place of a ceiling tile. An upper portion of the acoustic device 300 may be concealed above the ceiling tiles. Wiring to the acoustic device 300 (e.g., electrical wire and/or audio signal wire) can also be concealed above the ceiling tiles.

Dimensions of the acoustic device 300 can be designed to correspond to dimensions of a ceiling tile. For example, a ceiling tile in the United States is commonly 609.6 mm by 609.6 mm or 609.6 mm by 1219.2 mm and a ceiling tile in Europe is commonly 595 mm by 595 mm or 595 mm by 1195 mm. A lower portion of the speaker can be designed to fit within a standardized or non-standard sized ceiling tile.

FIG. 4 is an exploded diagram of a ceiling-mountable acoustic device 400, according to an embodiment. The exploded diagram shows components of the ceiling-mountable acoustic device 400 separated for the purpose of illustration. The ceiling-mountable acoustic device 400 can include any of a cover 402 (e.g., a conic cover), a diaphragm 404 (e.g., a perforated diaphragm), an driver (e.g., an electrodynamic exciter), a frame 406, a lining 408, and a ceiling mount 410.

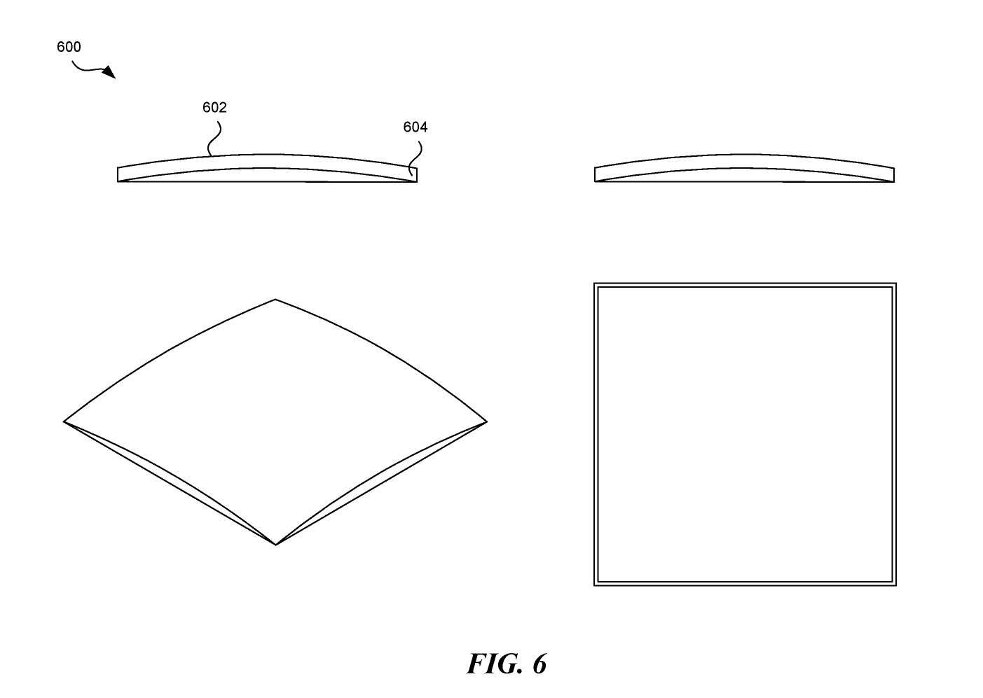

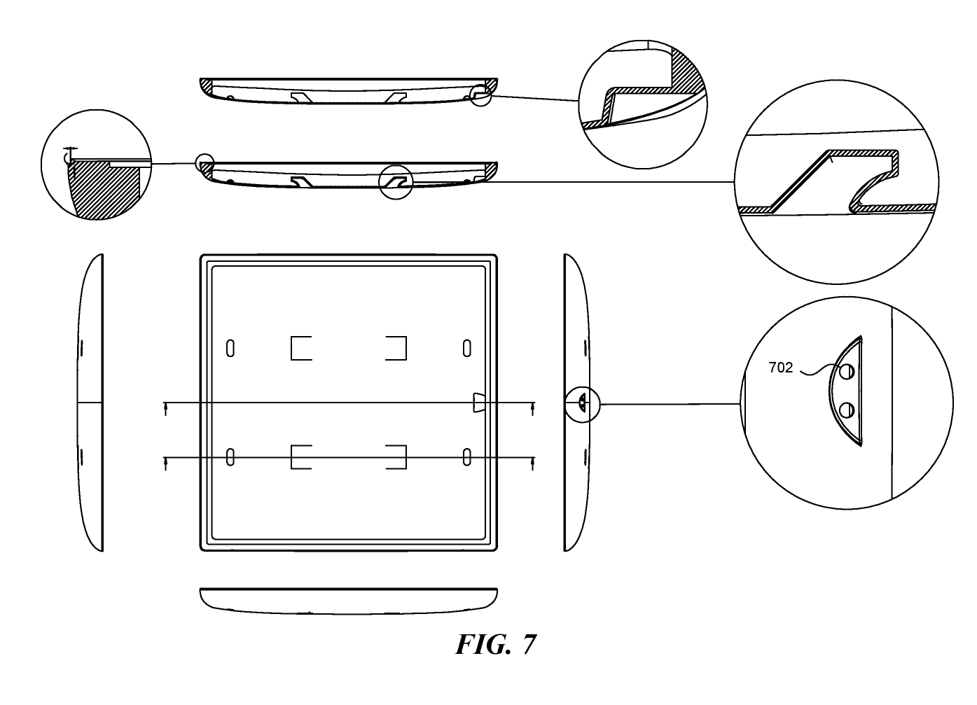

The cover reduces sound emanating in a direction from the diaphragm. For example, a ceiling-mounted speaker can include a cover on top so that sound waves travelling upward can be obstructed by the cover (e.g., to limit noise for upstairs neighbors). The cover can be shaped as a conic section (e.g., portion of a circle, ellipse, parabola, hyperbola, etc.). The conic section shape can reflect sound waves, causing sound waves contacting the conic shaped cover to reflect toward a singular focus. Various embodiments of the cover are discussed below with reference to FIGS. 6-8.

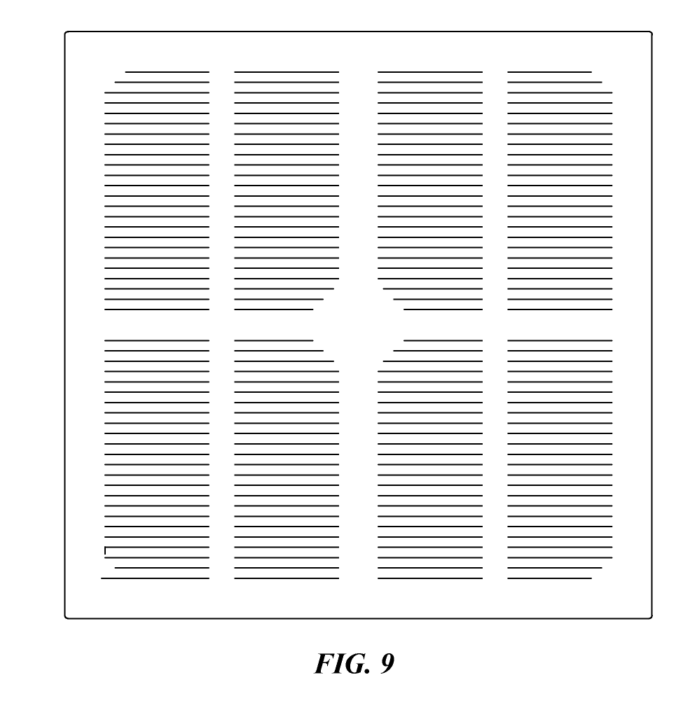

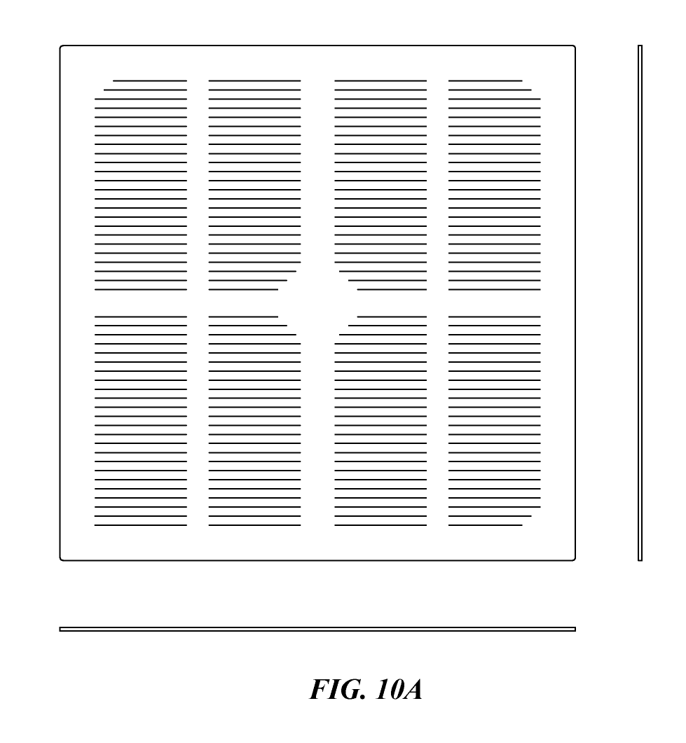

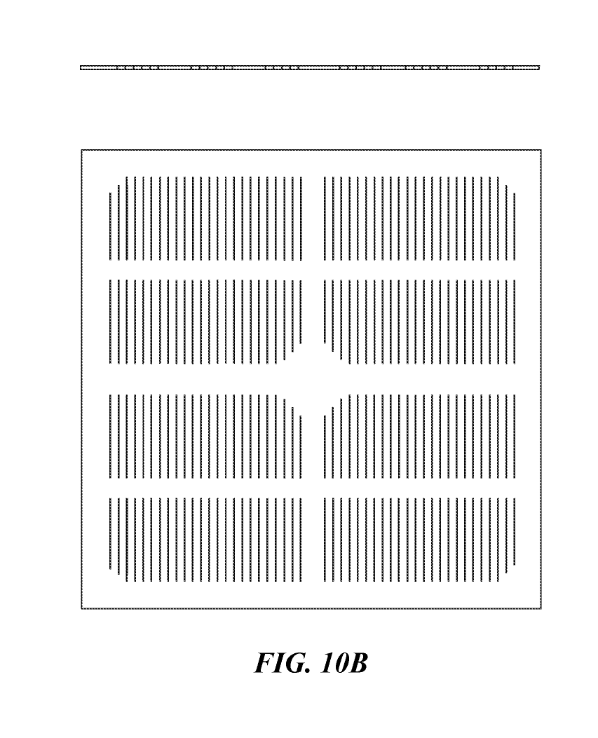

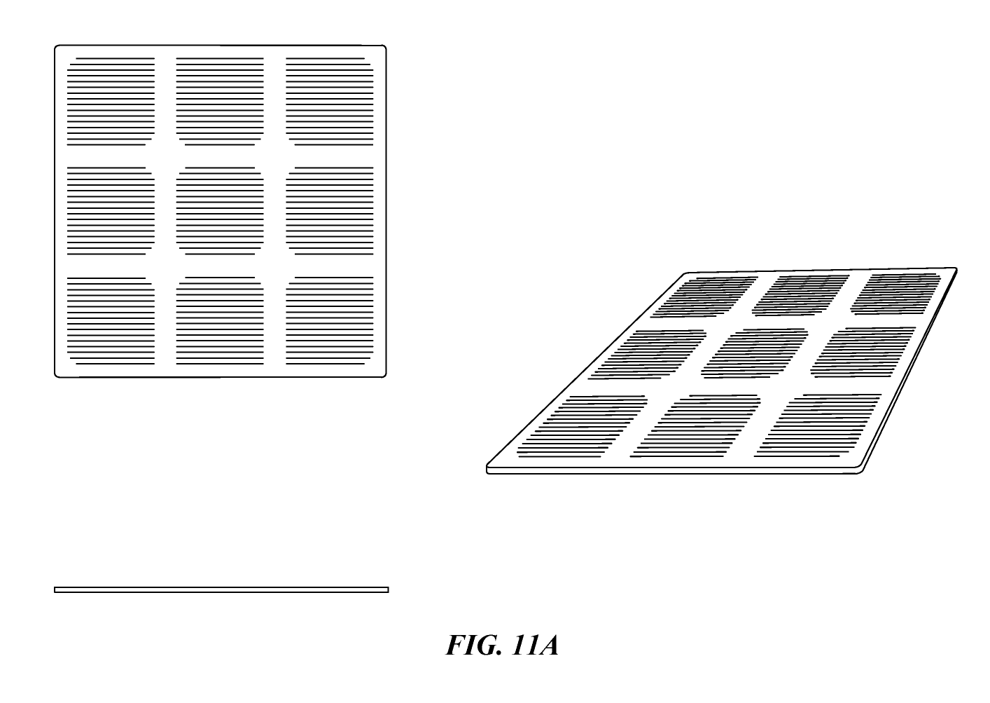

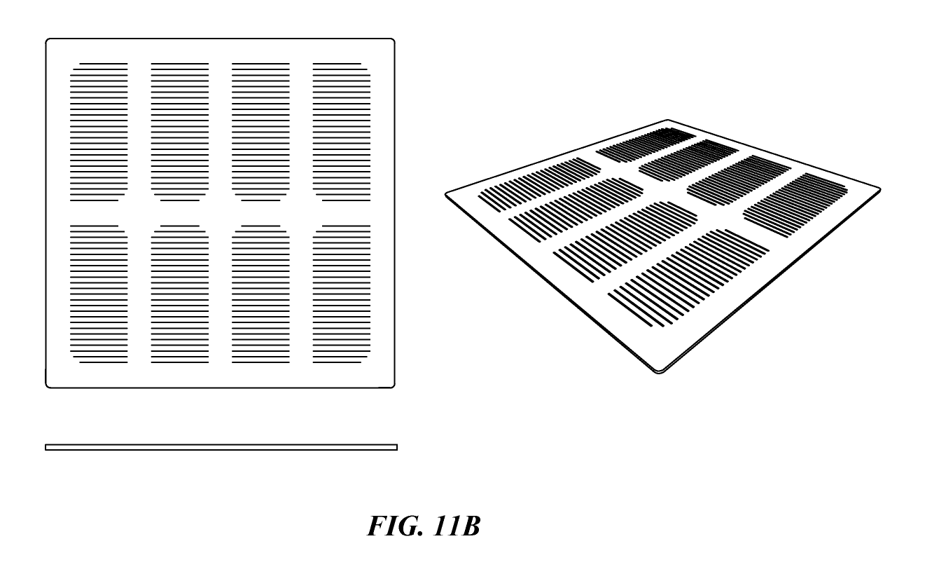

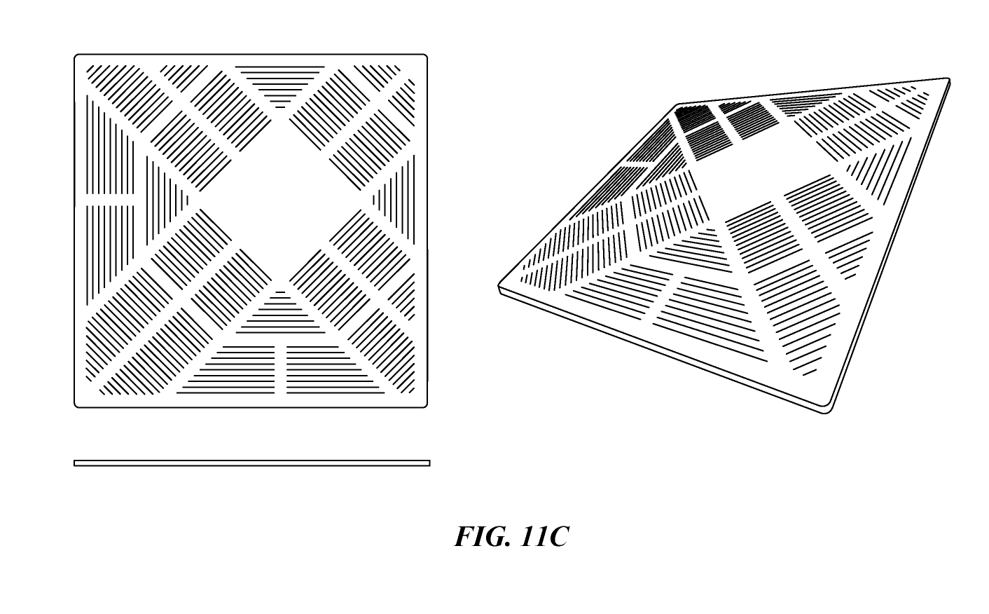

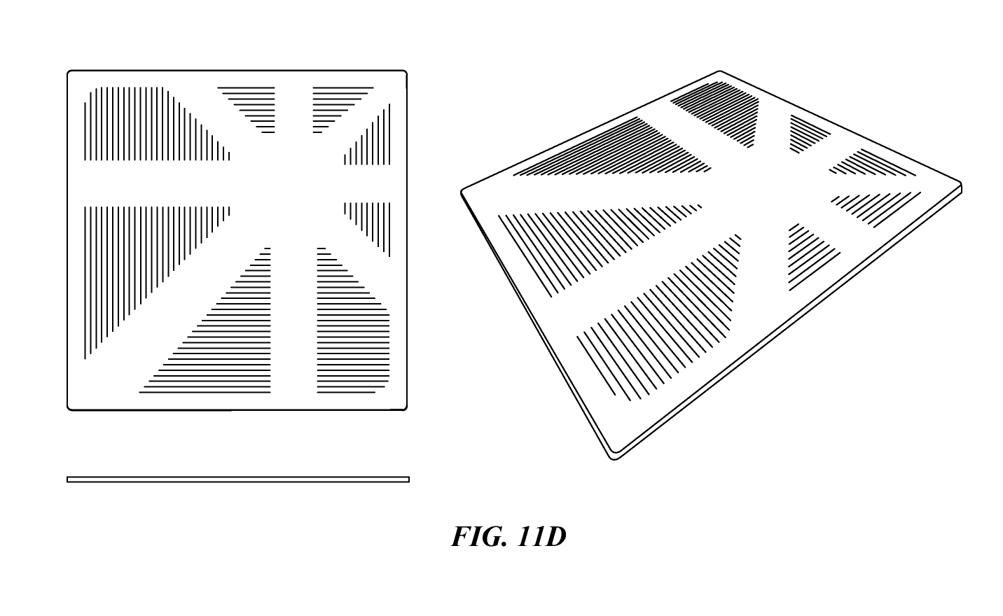

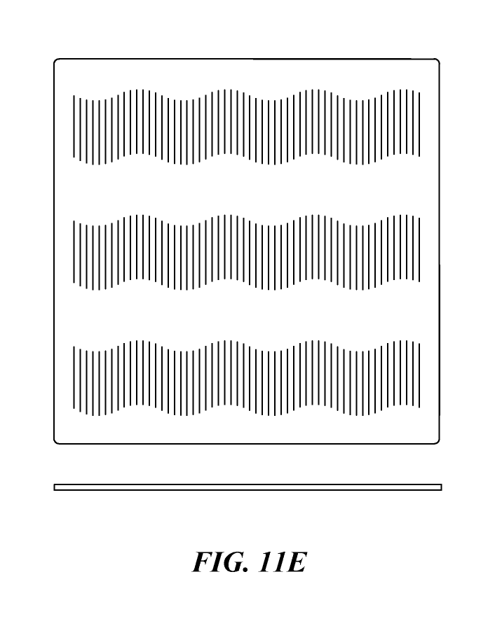

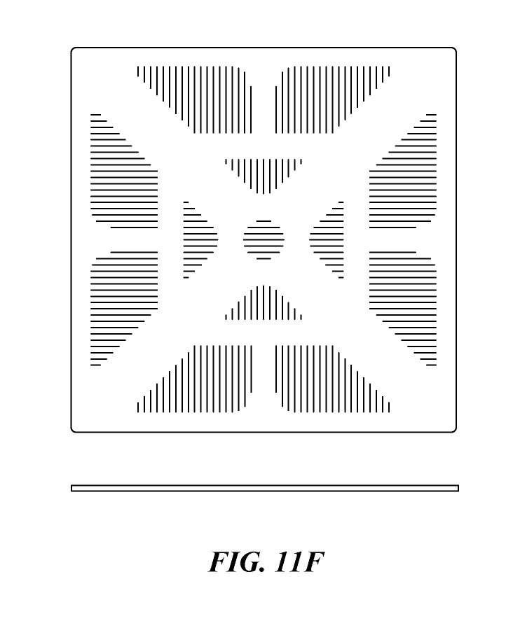

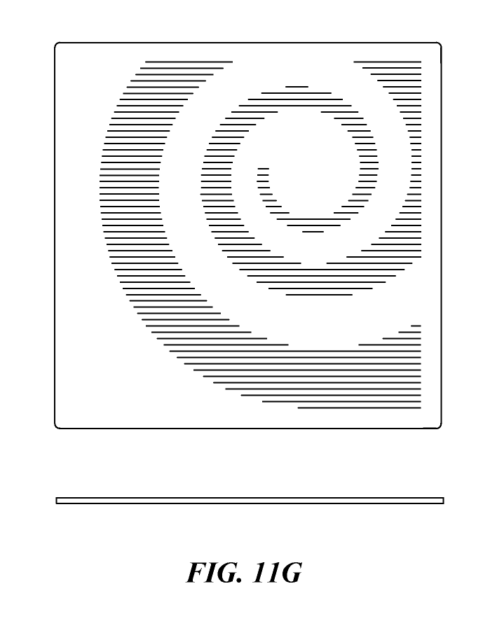

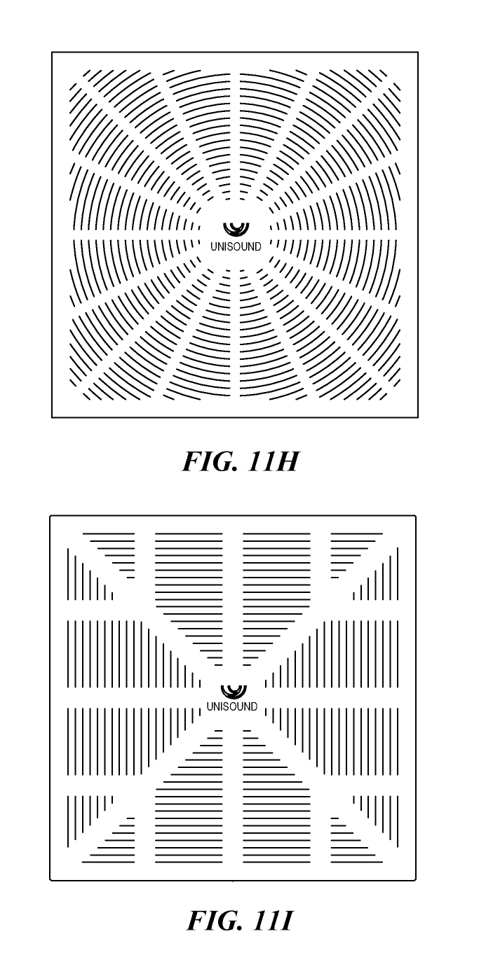

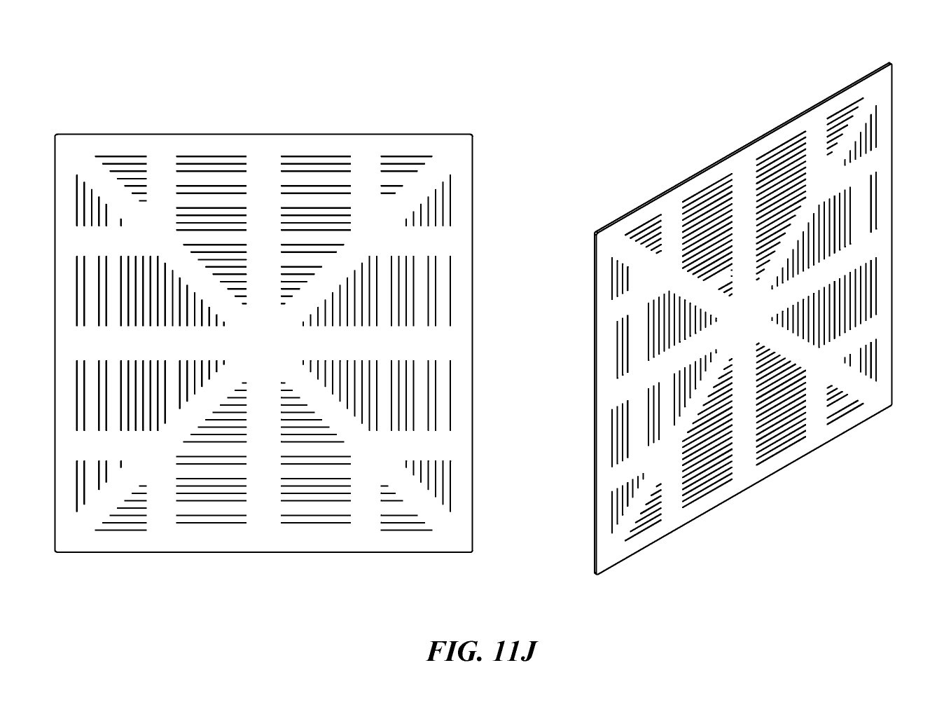

The diaphragm is a transducer to convert mechanical vibrations to sounds. Sound emanating from the diaphragm of the ceiling-mountable speaker is generated by vibrations in the diaphragm, where the vibrations originate from a driver connected to the diaphragm that converts an electromagnetic field into motion. The diaphragm can include perforations. The perforations in the diaphragm can alter an elastic deflection of the media with which the diaphragm is composed. Alterations of the elastic deflection of the diaphragm changes vibration patterns which can change sound dispersion qualities, frequency responses, and sound pressure level (e.g., intensity, amplitude, etc.). Embodiments of the disclosed technique enhance sound quality by utilizing diaphragm perforation designs that enables wider sound dispersion. Various embodiments of the diaphragm are discussed below with reference to FIGS. 9-11J.

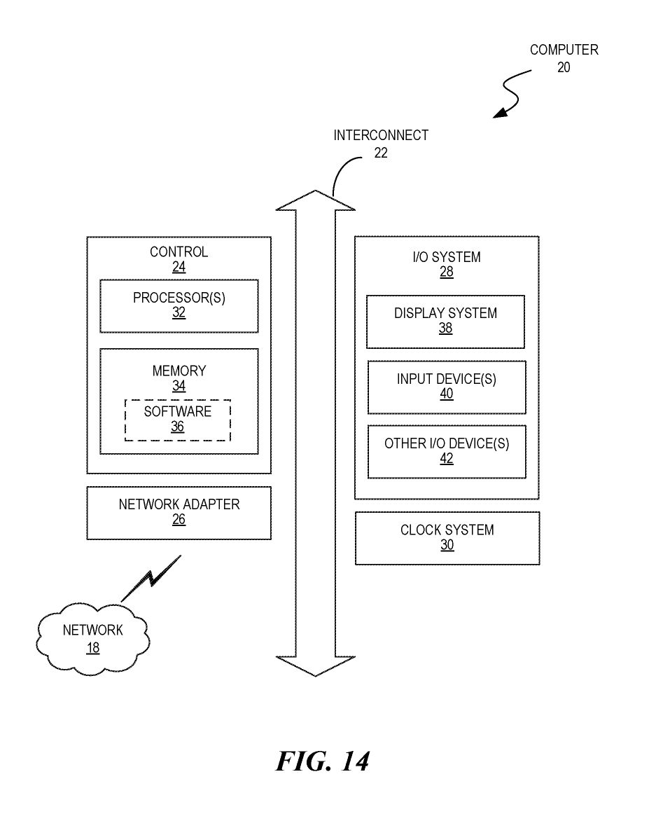

The driver is a transducer to convert electromagnetic energy into mechanical vibrations. The driver can be an electrodynamic exciter that converts an electromagnetic field into motion. The driver can be attached to, for example, a central portion of the diaphragm or a non-central portion of the diaphragm (e.g., any portion of the diaphragm lacking perforations). Preferred embodiments include attaching the driver to a portion of the diaphragm that lacks perforations (i.e. an unperforated portion of the perforated diaphragm). Attaching the driver to an unperforated portion can provide more rigid coupling and more efficient energy transfer from the driver to the diaphragm than attaching the driver to a perforated portion may provide. The driver is attached to the perforated diaphragm by screwing, adhesive, welding, rivets, snap connections, or any combination thereof. An alternating electric current can be directed through a coil in the driver to create an alternating magnetic field. The alternating magnetic field can cause an element in the driver to move at a speed corresponding to alternations in the magnetic field, resulting in a controlled vibration. The driver can be controlled by a computing device such as the computing device described below with reference to FIG. 14.

The frame holds the diaphragm in place and is attachable to the cover. The frame can be composed of a polymer such as, for example, acrylonitrile butadiene styrene. The frame can be attached to the cover by, for example, screwing, adhesive, welding, rivets, snap connections, or any combination thereof.

The lining is a vibration dampener to reduce vibration transfer from the diaphragm to the frame. Without a lining, the diaphragm could cause vibrations in the frame resulting in inferior sound quality. By reducing vibrations in the frame, the lining ensures that vibrations are substantially limited to the diaphragm, thus improving sound quality. In addition, the lining reduces any resonance that could occur when a mechanical wave propagates to an edge of the diaphragm and is reflected back toward the driver. The superposition of the original wave and the reflected wave could create interference effects as the reflected wave travels back towards the driver. The lining nearly eliminates reflection of mechanical waves from edges of the diaphragm, thus reducing interference in the diaphragm and improving sound quality.

The ceiling mount can be used to hang the speaker to a surface (e.g., a ceiling, wall, furniture, etc.). The ceiling mount can include a surface mounting mechanisms such as hold in corners so the speaker can be screwed into a surface. The ceiling mount is optional and may not be needed. For example, if a ceiling includes suspended ceiling tiles, the speaker can be inserted as a ceiling tile without the ceiling mount. In another example, even if a ceiling includes suspended ceiling tiles, the speaker can include the ceiling mount as an additional mounting mechanism to increase security (e.g., in areas at risk for earthquakes).

FIG. 5 is an exploded diagram of a ceiling-mountable acoustic device 500, according to an embodiment. The exploded diagram shows components of the ceiling-mountable speaker separated for the purpose of illustration. The ceiling-mountable acoustic device 500 can include a cover 502 (e.g., a conic cover), a diaphragm 504 (e.g., a perforated diaphragm), a driver 505 (e.g., an electrodynamic exciter), a frame 506, a lining 508, and (optionally) a ceiling mount (not shown). The cover can have a trapezoidal shape (as opposed to the conic shape shown in FIG. 4). Various shapes for the cover are contemplated.

FIGS. 6-8 are illustrations of conic covers for a ceiling-mountable speaker, according to an embodiment. The cover reduces sound emanating in a direction from the diaphragm. For example, a ceiling-mounted speaker can include a cover on top so that sound waves travelling upward can be obstructed by the cover (e.g., to limit noise for upstairs neighbors).

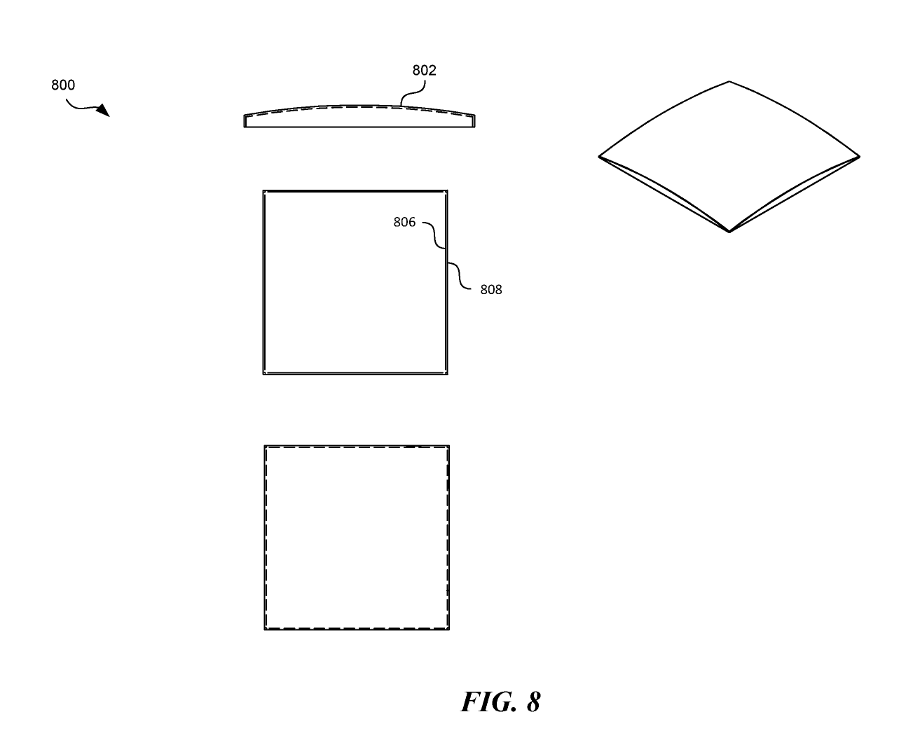

The cover can be configured in different shapes for different purposes. For example, the cover can be shaped as a conic section (e.g., portion of a circle, ellipse, parabola, hyperbola, etc.). As shown in FIG. 6, an upper surface 602 of a conic cover 600 can have a conic shape and a sidewall 604 of the conic cover 600 can be substantially flat lower surface (e.g., to come in contact with a planar diaphragm). As shown in FIG. 8, an upper surface 802 of a conic cover 800 can have a conic shape and an outer surface 808 and an inner surface 806 of a sidewall of conic cover 800 can extend substantially linearly along an outer region of the conic cover 800. An upper surface (e.g., upper surface 602 and/or upper surface 802) of the cover can have a conic shape of a section of a circle where the circle has a radius of 1690 mm. The conic section shape can reflect sound waves, causing sound waves contacting the conic shaped cover to reflect toward a singular focus or in a substantially uniform direction. For example, sound reflected by the cover can travel substantially downward. In another example, sound reflected by the cover can travel downward toward a focal point existing below the diaphragm. In an embodiment, the cover can include a surface of varying depths to diffuse sound. The surface can include, for example, strips of varying depths, checkered pattern of varying depths, arbitrary shapes of varying depths, or any combination thereof.

Dimensions and composition of the cover can vary based on speaker and environmental variables. The shape and dimensions of the cover can be based on the shape and dimensions of the diaphragm. In an embodiment, a cover can have a square footprint (i.e. square from a top view), rectangular footprint, or a footprint in any other two-dimensional shape. The cover can have a length ranging from approximately 50 mm to approximately 5000 mm, and ranges therebetween. For example, the cover can have a length ranging from approximately 400 mm to approximately 700 mm. In an example, the cover can have a width and a length of 586 mm.

FIGS. 9-11J are illustrations of a perforated diaphragm for a ceiling-mountable speaker, according to an embodiment. The diaphragm is a transducer that converts mechanical vibrations to sound. Sound emanating from the diaphragm of the ceiling-mountable speaker is generated by vibrations in the diaphragm, where the vibrations originate from a driver connected to the diaphragm that converts an electromagnetic field into motion.

The diaphragm can include perforations. For example, the diaphragm can include parallel perforations distributed in eight groupings as shown. The perforations in the diaphragm can alter an elastic deflection of the media with which the diaphragm is composed. Alterations of the elastic deflection of the diaphragm changes vibration patterns which can change frequency response, sound dispersion, timbre, coloring, and sound pressure level (e.g., intensity, amplitude, etc.). Embodiments of the disclosed technique enhance sound quality by utilizing diaphragm perforation designs (e.g., eight groupings of parallel perforations) that enables greater sound dispersion of high frequencies in a near field than is possible with conventional single source speakers.

Sound is produced by a mechanical vibration from a driver (e.g., an electrodynamic exciter). The mechanical waveform possesses characteristics such as frequency (f), wavelength (λ) and velocity (m/s) and the waveform is determined by the origin of the sound.

Further, elastic deflection in the media can be calculated based on mechanical vibration from the driver. For example, consider a simply-supported beam with an applied force in the center of the beam. Elastic deflection δ_{c} is represented by

$${δ}_{c} = \frac{{FL}^{3}}{48 EI}$$

where F is the force acting on the center of the beam, L is the length of the beam between the supports, E is Young's modulus (ratio between stress and strain for a chosen media), and I is the area moment of inertia for a cross section. It is important to note that the governing variables involve the physical dimensions of the beam. Therefore, if the beam spans a large area, the elastic deflection is small. In other words, there is an inverse relationship between the elastic deflection and the area. Furthermore, in order to achieve a larger elastic deflection, the area of the beam must be reduced.

In a diaphragm, an elastic deflection can be increased by reducing an area of the diaphragm. The area of the diaphragm can be reduced by including perforations in the diaphragm. A greater number of perforations and/or greater size of perforations reduces an area of the diaphragm having otherwise fixed dimensions. A target elastic deflection can be achieved in a diaphragm by reducing the area of the diaphragm with perforations. The higher the target elastic deflection of a diaphragm, the greater number and/or size of perforations that may need to be included to achieve the target elastic deflection. With an increased elastic deflection, the perforated diaphragm enhances sound quality, providing less coloring, reduced amount of standing waves/resonances in the material, and thus better speech intelligibility.

Due to the phenomenon of resonance, at certain vibration frequencies (i.e. resonant frequencies) a diaphragm can store vibrational energy where the surface moves in a characteristic pattern of standing waves. This is called a normal mode. A membrane has an infinite number of normal modes, starting with a lowest frequency (i.e. fundamental mode) and continuing to infinitely high frequencies. A standing wave is a wave in a diaphragm in which each point on an axis of the wave includes an associated constant amplitude. Locations at which the amplitude is minimum are called nodes, and locations where the amplitude is maximum are called antinodes. Standing waves can cause resonant interference and reduce sound quality.

A diaphragm having perforations can dampen standing waves due to wave interactions with a perforation boundary. Vibrations of a diaphragm can be determined by a two-dimensional wave equation with Dirichlet boundary conditions. Analyzing wave propagation in a diaphragm having perforations shows that standing waves are diminished due to a more complex geometric arrangement of the diaphragm having perforations. Waves interaction with perforation edges involves a complex boundary behavior that can include partial reflection and partial refraction. Thus, uniform “normal modes” across a complex geometric arrangement of a diaphragm having perforations is less likely to occur than in a diaphragm having a simple homogenous geometry. Complex wave interactions with perforations dampen standing waves, and thus decreases resonant interference from a diaphragm.

The perforations in the diaphragm also act as a combination of filters that allow certain ranges of frequencies to attenuate from the diaphragm. The perforations create smaller areas that help disperse the sound in the range of mid to high audio frequencies while the diaphragm as a whole disperses the low audio frequencies. The range of frequencies attenuated in the diaphragm effectively achieve the combination of tweeter, midrange, and bass speakers, respectively, all in one speaker system.

The vibrational waves travel through the media (diaphragm) then displace the air proximate to the media (diaphragm) to propagate sound. Vibrational wave travel patterns through the diaphragm are dictated based on the elastic deflection and geometry of the diaphragm. As a vibrational wave approaches a perforation, the vibrational wave diffracts. As vibrational waves approach a series of parallel perforations, the vibrational waves diffract into a complex pattern of varying intensity. The complex wave pattern traverses an area between neighboring perforations. Vibrations of areas between neighboring perforations displace proximate air and act as a series of parallel sound sources.

Sound waves emanating from the diaphragm have an amplitude equal to a vector sum of the amplitudes of the combined waveforms originating from areas between neighboring perforations. Vibrations of parallel sound sources can be modeled using pure line array theory. Pure line array theory is based on pure geometry and the thought experiment of the “free field” where sound is free to propagate free of environmental factors such as room reflections or temperature refraction.

In the free field, sound which has its origin at a point (a point source) is propagated equally in all directions as a sphere. Since the surface area of a sphere is 4π r² where r is the radius, every doubling of the radius results in a four-fold increase in the sphere's surface area. This results in sound intensity that quarters for every doubling of distance from the point source. Sound intensity is the acoustic power per unit area, and it decreases as the surface area increases since the acoustic power is spread over a greater area. The ratio between two acoustic pressures in decibels (dB) is expressed by the equation dB=20 log(p1/p2), where p1 and p2 are point sources. As the distance from the point source doubles, p1=1 and p2=2, there is a sound pressure decrease of approximately 6 dB.

A line source is a hypothetical one-dimensional source of sound, as opposed to the dimensionless point source. As a line source propagates sound equally in all directions in the free field, the sound propagates in the shape of a cylinder rather than a sphere. Since the surface area of the curved surface of a cylinder=2π r h, where r is the radius and h is the height, every doubling of the radius results in a doubling of the surface area, thus the sound pressure halves with each doubling of distance from the line source. Since p1=1 and p2=4 for every distance doubled, this results in a sound pressure decrease of approximately 3 dB.

The dispersion pattern of a line array is referred to as an “interference pattern”. If a number of speakers are stacked vertically, the vertical dispersion angle decreases because the individual drivers are out of phase with each other at listening positions off-axis in the vertical plane. The taller the stack, the narrower the vertical dispersion and the higher the sensitivity is on-axis.

By including one or more series of perforations, the speaker acts like a group of line arrays, effectively increasing dispersion and may maintain sound pressure higher than an equally loud line array. For instance, the diaphragm can include eight groups of parallel perforations, thus acting like a group of eight line arrays. Line arrays interact with adjacent line arrays just as adjacent point sources interact with adjacent point sources in a single line array. The eight groups of parallel perforations have a unique dispersion pattern that may provide sound pressure maintenance for every distance doubled superior to a line array. In addition, the eight series of perforations enables 180 degrees dispersion of frequencies up to 20 kHz.

Dimensions of the diaphragm can be designed to correspond to dimensions of other speaker components (e.g., cover) or an intended environment (e.g., a ceiling tile cell size). A width and a length of the diaphragm can range from approximately 50 mm to approximately 5000 mm, and ranges therebetween. For example, the width and length of the diaphragm can be approximately 568 mm.

In an embodiment, the diaphragm can include eight groups of parallel perforations. Each group of parallel perforations can be separated from a neighboring group by a distance ranging from approximately 3 mm to approximately 300 mm, and ranges therebetween. For example, groups of parallel perforations can be separated from neighboring groups by at least 25.5 mm. Each group of parallel perforations can be approximately rectangular. In an example, groups of parallel perforations can have a width of 100 mm and a length of 230 mm. Groups of perforations adjacent to a center portion of the diaphragm can include a taper such that an un-perforated region exists in the center portion. The driver can be attached to the center portion of the diaphragm. Groups of perforations adjacent to a corner of the diaphragm can include a taper such that an un-perforated region exists near each corner of the diaphragm. The perforations can be a minimum distance away from an outer edge of the diaphragm to maintain a threshold of robustness. For example, the perforations can be at least 39 mm away from the outer edge of the diaphragm. Maintaining framework conditions of the diaphragm (e.g., an outer un-perforated region and inner un-perforated regions) can ensure that the diaphragm has the ability to produce high, mid, and low frequencies.

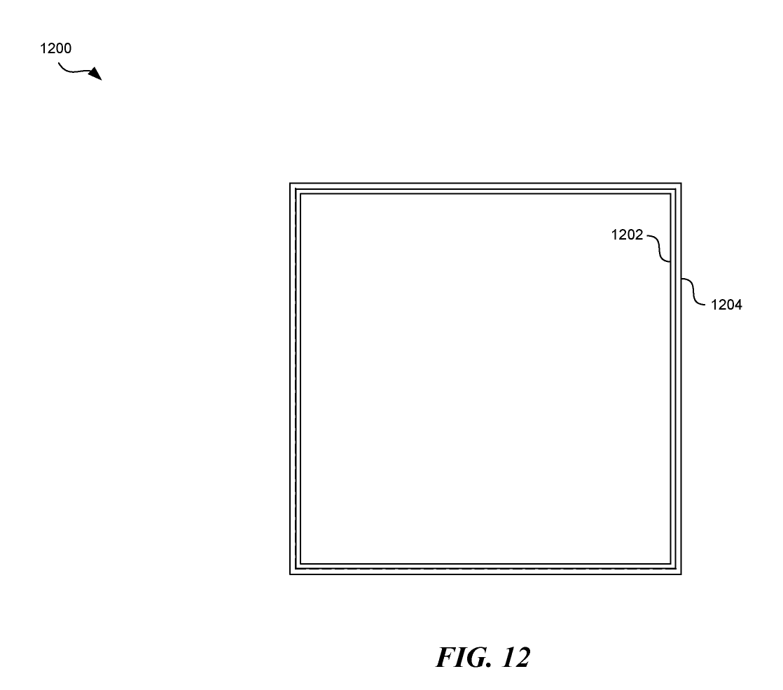

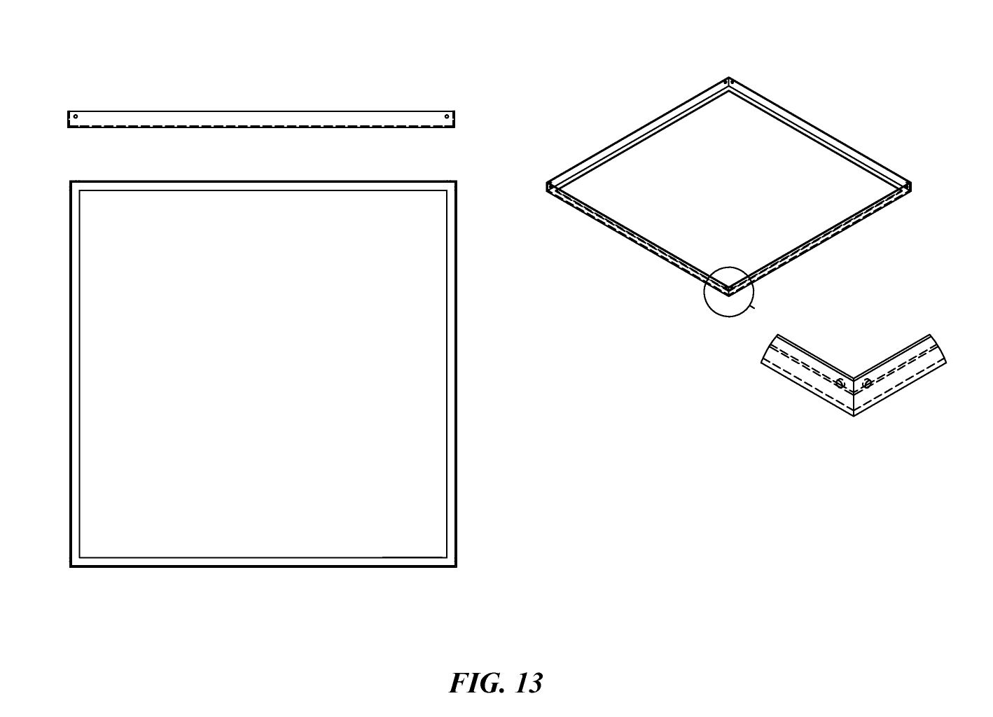

FIG. 12 is an illustration of a frame 1200 for a ceiling-mountable passive loudspeaker, according to an embodiment. The frame 1200 includes an upper flange 1204 and a lower flange 1202. The frame holds the diaphragm in place and is attachable to the cover. For example, an outer surface of the diaphragm can rest on the lower flange 1202. The frame 1200 can be composed of a metal (e.g., aluminum), a polymer (e.g., acrylonitrile butadiene styrene), or a combination of materials. The frame 1200 (e.g., the upper flange 1204 of the frame 1200) can be attached to the cover by, for example, screwing, adhesive, welding, rivets, snap connections, or any combination thereof.

In an embodiment, the ceiling-mountable speaker can include a linking between the diaphragm and the frame. The lining reduces standing waves and reflections inside the case. The lining also serves as a vibration dampener to reduce vibration transfer from the diaphragm to the frame. Without a lining, the diaphragm could cause vibrations in the frame resulting in inferior sound quality. By reducing vibrations in the frame, the lining ensures that vibrations are substantially limited to the diaphragm, thus improving sound quality. In addition, the lining reduces resonance that could occur when a mechanical wave propagates to an edge of the diaphragm and is reflected back toward the driver. The superposition of the original wave and the reflected wave could create interference effects as the reflected wave travels back towards the driver. The lining nearly eliminates reflection of mechanical waves from edges of the diaphragm, thus reducing interference in the diaphragm and improving sound quality.

Dimensions of the frame can be designed to correspond to dimensions of other speaker components (e.g., diaphragm) or an intended environment (e.g., a ceiling tile cell size). A width and a length of the frame can range from approximately 50 mm to approximately 5000 mm, and ranges therebetween. For example, the width and length of the frame can be approximately 586 mm.

FIG. 13 is an illustration of a ceiling mount for a ceiling-mountable passive acoustic device (e.g., a loudspeaker), according to an embodiment. The ceiling mount can be used to hang the speaker to a surface (e.g., a ceiling, wall, furniture, etc.). The ceiling mount is optional and may not be needed. For example, if a ceiling includes suspended ceiling tiles, the speaker can be inserted as a ceiling tile without the ceiling mount. In another example, even if a ceiling includes suspended ceiling tiles, the speaker can include the ceiling mount as an additional mounting mechanism to increase security (e.g., in areas at risk for earthquakes) and/or to reduce vibrations to a suspended ceiling structure.

The ceiling mount can include a surface mounting mechanisms such as hold in corners so the speaker can be screwed into a surface. For example, the ceiling mount can include holes in one or more corners configured to receive a bolt so the ceiling mount can be bolted to a surface.

The ceiling mount can be composed of, for example, a metal, polymer, ceramic, or any combination thereof. For example, the ceiling mount can be a steel plate. Dimensions of the ceiling mount can vary based on speaker variables (e.g., dimensions, weight, etc.) and on a material used for the ceiling mount. In an example, the ceiling mount can be 2 mm thick steel plate.

### Computer

FIG. 14 is a diagrammatic representation of a machine in the example form of a computer system 1400 within which a set of instructions, for causing the machine to perform any one or more of the methodologies or modules discussed herein, may be executed.

In the example of FIG. 14, the computer system 1400 includes a processor, memory, non-volatile memory, and an interface device. Various common components (e.g., cache memory) are omitted for illustrative simplicity. The computer system 1400 is intended to illustrate a hardware device to manage audio data used in FIGS. 1-13 (and any other components described in this specification) can be implemented. For example, the computer system 1400 can be integrated into various embodiments of the disclosed speaker to receive audio data and control electric current directed to the driver. In another example, the computer system 1400 can be integrated into various embodiments of the disclosed speaker for identifying and managing vibrations in the diaphragm.

The computer system 1400 can be of any applicable known or convenient type. The components of the computer system 1400 can be coupled together via a bus or through some other known or convenient device.

This disclosure contemplates the computer system 1400 taking any suitable physical form. As example and not by way of limitation, computer system 1400 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, computer system 1400 may include one or more computer systems 1400; be unitary or distributed; span multiple locations; span multiple machines; or reside in a cloud, which may include one or more cloud components in one or more networks. Where appropriate, one or more computer systems 1400 may perform without substantial spatial or temporal limitation one or more steps of one or more methods described or illustrated herein. As an example and not by way of limitation, one or more computer systems 1400 may perform in real time or in batch mode one or more steps of one or more methods described or illustrated herein. One or more computer systems 1400 may perform at different times or at different locations one or more steps of one or more methods described or illustrated herein, where appropriate.

The processor may be, for example, a conventional microprocessor such as an Intel Pentium microprocessor or Motorola PowerPC microprocessor. One of skill in the relevant art will recognize that the terms “machine-readable (storage) medium” or “computer-readable (storage) medium” include any type of device that is accessible by the processor.

The memory is coupled to the processor by, for example, a bus. The memory can include, by way of example but not limitation, random access memory (RAM), such as dynamic RAM (DRAM) and static RAM (SRAM). The memory can be local, remote, or distributed.

The bus also couples the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer system 1400. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software is typically stored in the non-volatile memory and/or the drive unit. Indeed, storing an entire large program in memory may not even be possible. Nevertheless, it should be understood that for software to run, if necessary, it is moved to a computer readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

The bus also couples the processor to the network interface device. The interface can include one or more of a modem or network interface. It will be appreciated that a modem or network interface can be considered to be part of the computer system 1400. The interface can include an analog modem, ISDN modem, cable modem, token ring interface, satellite transmission interface (e.g., “direct PC”), or other interfaces for coupling a computer system to other computer systems. The interface can include one or more input and/or output devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device. For simplicity, it is assumed that controllers of any devices not depicted in the example of FIG. 20 reside in the interface.

In operation, the computer system 1400 can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux™ operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may thus be implemented using a variety of programming languages.

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies or modules of the presently disclosed technique and innovation.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

### REMARKS

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling others skilled in the relevant art to understand the claimed subject matter, the various embodiments, and the various modifications that are suited to the particular uses contemplated.

While embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Although the above Detailed Description describes certain embodiments and the best mode contemplated, no matter how detailed the above appears in text, the embodiments can be practiced in many ways. Details of the systems and methods may vary considerably in their implementation details, while still being encompassed by the specification. As noted above, particular terminology used when describing certain features or aspects of various embodiments should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless those terms are explicitly defined herein. Accordingly, the actual scope of the invention encompasses not only the disclosed embodiments, but also all equivalent ways of practicing or implementing the embodiments under the claims.

The language used in the specification has been principally selected for readability and instructional purposes, and it may not have been selected to delineate or circumscribe the inventive subject matter. It is therefore intended that the scope of the invention be limited not by this Detailed Description, but rather by any claims that issue on an application based hereon. Accordingly, the disclosure of various embodiments is intended to be illustrative, but not limiting, of the scope of the embodiments, which is set forth in the following claims.

What is claimed is:

1. An acoustic diaphragm, comprising:
a planar shape configured for mounting in a ceiling; and
a plurality of perforations extending through the acoustic diaphragm and having a geometric arrangement extending laterally along the acoustic diaphragm,
wherein a first region of the acoustic diaphragm between neighboring perforations among the plurality of perforations is configured to move independently of a second region between other neighboring perforations among the plurality of perforations.

2. The acoustic diaphragm of claim 1, wherein the planar shape includes any polygon, ellipse, or any other shape bounded by any combination of straight or curved sides.

3. The acoustic diaphragm of claim 1, wherein the first region and the second region move in response to vibrations caused by a driver attached to a non-perforated region of the acoustic diaphragm.

4. The acoustic diaphragm of claim 1, wherein the first region and second region of the acoustic diaphragm are configured to cause sound wave propagation, wherein the propagating sound waves become incident on a same point causing a resultant wave having an amplitude equal to a vector sum of the amplitudes of initially emanated sound waves.

5. An acoustic apparatus, comprising:
a diaphragm having a two-dimensional plane and a depth;
a plurality of perforations extending through the depth of the acoustic diaphragm and having a geometric arrangement along the two-dimensional plane of the acoustic diaphragm; and
a driver attached to a non-perforated region of the diaphragm, the driver being configured to cause vibrations in regions of the diaphragm between any of the plurality of perforations.

6. The acoustic apparatus of claim 5, wherein the geometric arrangement includes a series of parallel perforations extending a length across the two-dimensional plane of the diaphragm.

7. The acoustic apparatus of claim 5, wherein the geometric arrangement includes at least a first series of parallel perforations and a second series of parallel perforation extending a length across the two-dimensional plane of the diaphragm.

8. The acoustic apparatus of claim 5, wherein a first region of the diaphragm between neighboring perforations among the plurality of perforations moves independently of a second region between other neighboring perforations among the plurality of perforations in response the driver causing vibrations.

9. The acoustic apparatus of claim 5, wherein upon the driver causing vibrations, sound wave propagation results from sound waves emanating from regions of the diaphragm between neighboring perforations of among the plurality of perforations, wherein the emanating sound waves become incident on a same point causing a resultant wave having an amplitude equal to a vector sum of the amplitudes of the emanating sound waves.

10. The acoustic apparatus of claim 5, wherein the driver is attached to the perforated diaphragm by screwing, adhesive, welding, rivets, snap connections, or any combination thereof.

11. The acoustic apparatus of claim 5, wherein the diaphragm is mounted to a medium-density frame.

12. The acoustic apparatus of claim 5, wherein the diaphragm is formed in a planar shape, wherein the planar shape includes any polygon, ellipse, or any other shape bounded by any combination of straight or curved sides.

13. The acoustic apparatus of claim 5, further comprising:
a conic cover enclosing a side of the diaphragm.

14. The acoustic apparatus of claim 13, wherein the conic cover is configured to restrict sound emanation of the side of the diaphragm upon the driver causing vibrations.

15. The acoustic apparatus of claim 5, wherein the perforation are configured to dampen vibrations and cancel out modes in the diaphragm to enable frequency tuning without changing a size of the diaphragm.

16. The acoustic apparatus of claim 5, wherein the perforations are configured for re-arrangement to alter sound dispersion.

17. The acoustic apparatus of claim 5, wherein a ratio of a perforated area of the diaphragm to a non-perforated area of the diaphragm causes an elastic deflection of the diaphragm to exceed a threshold.

18. The acoustic apparatus of claim 5, wherein the diaphragm is composed of poly(methyl methacrylate) (PMMA), wood, glass, metal, ceramic, or a combination thereof.

19. An acoustic apparatus, comprising:
an acoustic diaphragm having a planar shape;
a plurality of perforations having a geometric arrangement in the acoustic diaphragm, wherein the geometric arrangement of the plurality of perforations cause an elastic deflection of the diaphragm to exceed a threshold; and
a conic cover enclosing a side of the diaphragm, wherein the conic cover is configured to restrict sound emanation of the side of the diaphragm.

20. The acoustic apparatus of claim 19, wherein the conic cover includes a curvature configured to reflect sound is a substantially uniform direction.

21. The acoustic apparatus of claim 19, further comprising:
a driver attached to a non-perforated region of the diaphragm.

22. The acoustic apparatus of claim 21, the driver being configured to cause vibrations in regions of the diaphragm between any of the plurality of perforations.

23. The acoustic apparatus of claim 19, wherein a size of any of the plurality of perforations further cause the elastic deflection of the diaphragm to exceed the threshold.

24. The acoustic apparatus of claim 19, wherein the planar shape includes any polygon, ellipse, or any other shape bounded by any combination of straight or curved sides.
